(19) United States
(12) Patent Application Publication
(10) Pub. No.: US 2005/0203849 A1
(43) Pub. Date: Sep. 15, 2005

(54) Multimedia distribution system and method

(76) Inventor: Bruce Benson, New Haven, CT (US)

Correspondence Address: GOODWIN PROCTER L.L.P, 103 EISENHOWER PARKWAY, ROSELAND, NJ, 07068, US

(21) Appl. No.: 10/961,565

(22) Filed: Oct. 8, 2004

Related U.S. Application Data
(60) Provisional application No. 60/510,480, filed on Oct. 9, 2003.
(60) Provisional application No. 60/552,173, filed on Mar. 10, 2004.

(51) Int. Cl. G06F 17/60

(52) U.S. Cl. 705/51; 705/52

(57) ABSTRACT

Provided herein are several exemplary embodiments of a system and method for distributing content via a network. In particular, copies of the digital content are modified to permit the incorporation of additional content, such as advertising. Because the content is copied broadly, this invention facilitates the dissemination of this additional content to many consumers. In one embodiment, advertising is incorporated into a song stored in, for example, a MP3 format. As the songs are distributed using methods that may include, but is not limited to, sharing compact discs, sharing of digital files via direct transfer (disc to disc), sharing over Peer-to-Peer networks or distribution via Internet websites or portals, the advertising is also distributed and reaches a very broad consumer base.

### CLAIM OF PRIORITY/CROSS REFERENCE OF RELATED APPLICATION(S)

This application claims the benefit of priority of U.S. Provisional Application Nos. 60/474,380, filed May 29, 2003, 60/510,480, filed Oct. 9, 2003, and 60/552,173, filed Mar. 10, 2004, each of which is hereby incorporated in its entirety herein by reference.

### STATEMENT REGARDING FEDERALLY SPONSORED RESEARCH OR DEVELOPMENT

Not applicable.

### REFERENCE TO AN APPENDIX

Not applicable

### BACKGROUND OF THE INVENTION

1. Field of the Invention

This invention generally relates to data processing systems and methods and more particularly to methods of distributing information, such as advertising, music and video over networks.

2. Description of the Related Art

The transformation of content, such as music and video, into digital format has revolutionized the enjoyment and distribution of the content. Digital formats means that a song or video can be played back many times by a computer or a portable electronic device without degradation of sound or video quality. It also means that copies made are identical to the original and are not degraded by multiple copies. Moreover, digital formats also mean that the content can be easily transmitted over, for instance, the Internet to others, possibly in violation of intellectual property laws, such as copyright laws.

The channels of content distribution are varied. They range from Internet portals to download content to peer-to-peer (“P2P”) networks where file sharing is open and rampant. Though Internet portals that allow legitimate downloads of content for payment are trying to gain a foothold, a vast amount of content is still distributed via P2P networks where illegal file sharing of copyrighted materials is distributed. This type of file sharing has created a significant loss of revenue to the music and film industry which is grappling with how to regain control over their content distribution. In one example, the music industry is currently attempting to curb copyright infringing file sharing of songs by litigation and legislation. This has created a paradoxical situation whereby the music industry is actively suing or threatening to sue the very consumers it wants as loyal customers. Additionally, the music industry and software companies are creating technological solutions which force consumers to restrict the manner the content may be used, even though a consumer may have legally paid for the content. To date, efforts to curb illegal activity has, by all measures, been marginally successful.

### SUMMARY OF THE INVENTION

The present invention overcomes many of the disadvantages of trying to rein in the illegal file sharing of digital content. The present invention takes advantage of the propensity for consumers to self-distribute and download copies of the digital content. This includes, but is not limited, to making copies of and sharing compact discs, sharing digital files via direct transfer (disc-to-disc), sharing over Peer-to-Peer networks or distribution via Internet websites or portals. In accordance with one aspect of the present invention, digital content is modified to incorporate or embed additional content, such as advertising. In one embodiment, the advertisement and the content are, for example, incorporated into one digital file and made available for consumers to download. Because the content is copied broadly, this invention facilitates the dissemination of this additional content to many consumers. For instance, advertising is incorporated into a song stored in, for example, a MP3 format. As the songs are distributed using methods that may include, but is not limited to, sharing compact discs, sharing of digital files via direct transfer (disc-to-disc), sharing over Peer-to-Peer networks or distribution via Internet websites or portals, the advertising is also distributed and reaches a very broad consumer base.

In accordance with another aspect of the present invention, content is encrypted and can be played only by a client designed to decrypt the content. The client can then plays ads incorporated in to the content or play ads stored separate from the content, but because the client has control, it also has control of when to play ads and what ads to play.

To generate revenue, in accordance with another aspect of the present invention, there is provided a content distribution and revenue generation system, comprising: a processor configured to: receive a first and second content; combine said first content with said second content; lock at least said first content; receive a user request for said first content from a user device; in response to said user first content request, transmit said combined content to said user device; and maintain impressions and billing information based on said transmission of said combined content.

Additional aspects, features and advantages of the present invention will become better understood with regard to the following description, appended claims, and accompanying drawings.

### BRIEF DESCRIPTION OF THE DRAWINGS

FIG. 1 depicts one exemplary embodiment of a multimedia distribution system in accordance with the teachings herein.

FIG. 2 is an alternative view of the multimedia distribution system of FIG. 1.

FIG. 3 depicts one exemplary embodiment of a multimedia distribution system highlighting the Song Management Server component.

FIG. 4 depicts one exemplary embodiment of a multimedia distribution system highlighting the Ad Sales Server component.

FIG. 5 depicts one exemplary embodiment of a multimedia distribution system highlighting the Ad Management Server component.

FIG. 6 depicts one exemplary embodiment of a multimedia distribution system highlighting the Client Management Server component.

FIG. 7 depicts one exemplary embodiment of a multimedia distribution system highlighting the Client component.

FIG. 8 depicts one exemplary embodiment of a multimedia distribution system highlighting the Song & Ad Server component.

FIG. 9 depicts one exemplary embodiment of a data structure utilized in the present invention.

FIG. 10 depicts one exemplary embodiment of a report generated by the present invention.

### DETAILED DESCRIPTION OF THE INVENTION

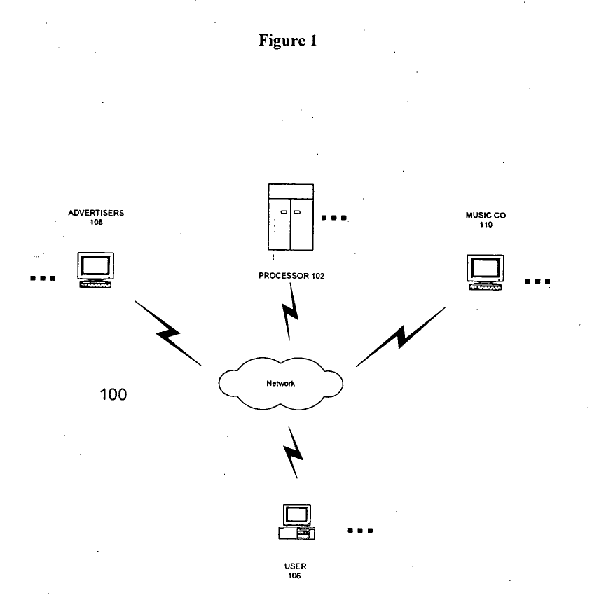

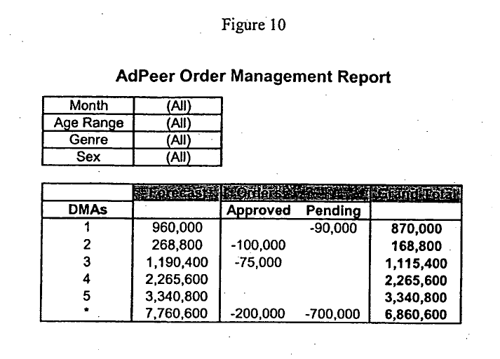

Referring more specifically to the drawings, for illustrative purposes the present invention is embodied in the exemplary system configuration, method of operation and product or computer-readable medium, such as floppy disks, conventional hard disks, CD-ROMs, DVD-ROMs, Flash ROMs, nonvolatile ROM, RAM and any other equivalent computer memory device, generally shown in FIGS. 1-10. It will be appreciated that the system, method of operation and program product may vary as to the details of its configuration and operation without departing from the concepts disclosed herein.

Although music is provided in an exemplary manner of content throughout this document, it should be noted that advertising supported, downloadable content (including streaming content), could be in any form, for example, video, gaming, television or the like. Therefore, numerous other embodiments of the modifications thereof are contemplated as falling within the scope of the present invention as defined herein and equivalents thereto.

FIG. 1 depicts an exemplary embodiment of a system 100 in accordance with the present invention including a central processor 102 executing a computer program to implement and control a multimedia distribution system. Central processor 102 is operably coupled to a communications medium 104. Optionally, central processor 102 is operably coupled to a database (not shown). At least one, user, advertiser and music company network enabled device (106, 108, 110, respectively) is operably coupled to the central processor 102 via the communications medium 104.

Central processor 102 can be any computing device, i.e., main-frame, super-mini, mini-computer system, clusters or personal computers (“PCs”) adapted to perform the methods described herein. In one emboidment the central processor 102 provides a centralized conduit for the collection and transfer of content between, for example, advertisers and music companies, and in the process also provides a centralized storage medium, which accumulates pertinent data. In one embodiment, the central processor runs an operating system with multi-tasking capabilities. Even though shown as one unit in FIG. 1, it is understood that central processor 102 can be a distributed system compise of a number of computing devices.

Communications medium 104 may take a variety of forms and need only provide reliable data communication between components. Examples thereof include: a wide area network, a local area network, a satellite/wireless/radio communications network, a commercial value added network (VAN), the Internet, ordinary telephone lines, private leased lines, etc.

A user/consumer interfaces with the system 100 via at least one network enabled input/output device 106 operably coupled to the communications medium 104. The user network-enabled device 106 is for, among other things, sending and receiving data to and from the central processor 102 over the communications medium 104, for example. The user network enabled device 106 may be a PC—desktop or portable, mobile device, personal digital assistant (“PDA”), or other suitable network enabled computing device.

An advertiser interfaces with the system 100 via at least one network enabled input/output device 108 operably coupled to the communications medium 104. The advertiser network enabled device 108 is for, among other things, sending and receiving data to and from the central processor 102 over the communications medium 104, for example. The advertiser network enabled device 108 may be a PC—desktop or portable, mobile device, PDA, or other suitable network enabled computing device.

A music label/company interfaces with the system 100 via at least one network enabled input/output device 110 operably coupled to the communications medium 104. The music company network-enabled device 110 is for, among other things, sending and receiving data to and from the central processor 102 over the communications medium 104, for example. The music company network enabled device 110 may be a PC—desktop or portable, mobile device, PDA, or other suitable network enabled computing device.

An embodiment of the present invention will now be discussed in greater detail. In particular, one or more embodiments using the technology claimed in this patent to implement one or more of the following functions: (1) force a user to listen to the advertisement each and every time they play a free song; (2) maximize revenue against the ads; (3) distribute ad-embedded songs or songs and ads separately; (4) report impressions to advertisers; (5) report revenue earned by the music companies; (6) encrypt the songs before distribution to consumers to ensure ad placement and tracking against all consumers who wish to play the song; and (7) replace “expired” ads with fresh content or ads when appropriate. These emboidments will sometimes be referred to herein as “Adeer™”. All rights in Adeer™ are expressly reserved.

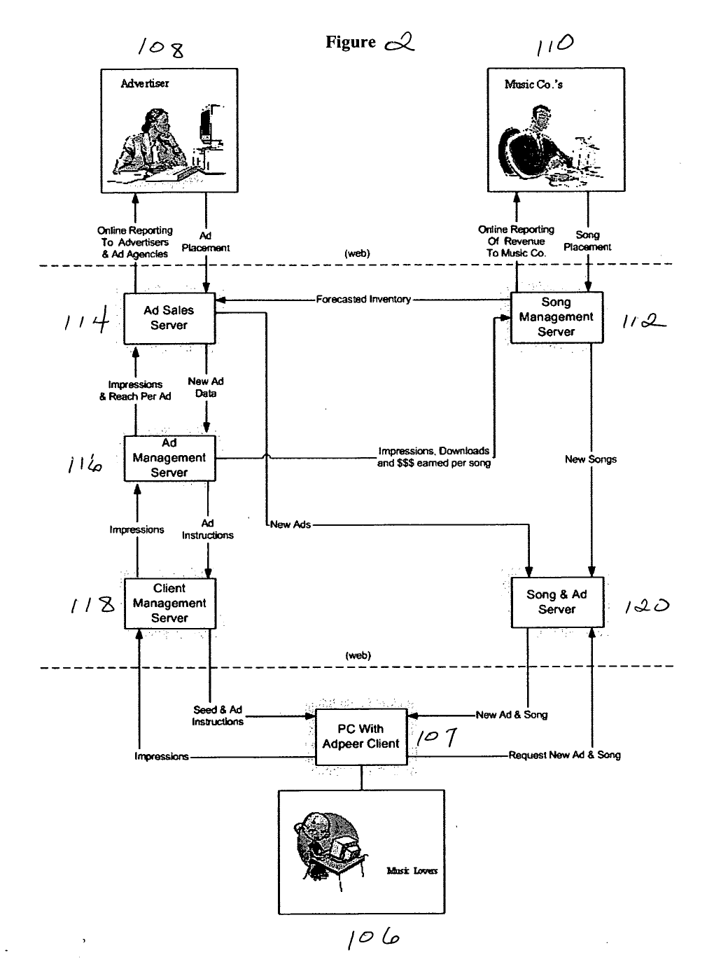

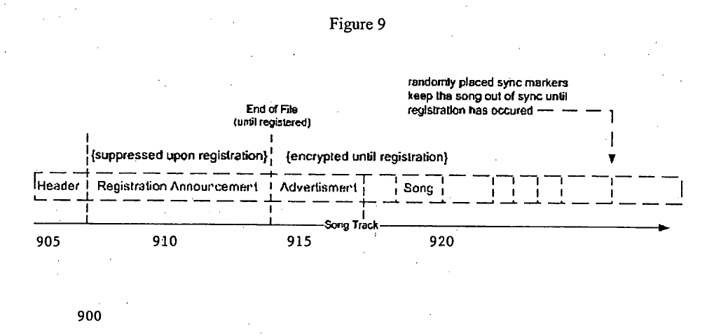

The present invention includes a computer program product, which embodies the functions and methods described herein. FIG. 2 depicts an exemplary embodiment of the computer program aspects of the invention. As shown, the central processor 102 contains one or more Adpeer Server Application(s) 103 having several components: Song Management Server 112, Ad Sales Server 114, Ad Management Server 116, Client Management Server 118, and Song & Ad Server 120. The user device 101 contains an Adpeer Client Application 107 for interfacing with the Adpeer Sever Application 103. Central to the invention is the generation and utilization of an Adpeer Song (FIG. 9).

1. AdPeer Song 900

The present invention uses a data structure that encodes a first content, such as music or video, with a second content, such as promotional information. Referring to FIG. 9, an Adpeer Song 900 is one embodiment of the data structure that encodes content and advertising. An advertiser provides desired advertising and a music company selects a (preferably popular) song for the Adpeer song 900 for the purposes of generating advertising revenue. The Adpeer system distributes the Adpeer song 900 over various networks and then sells advertising space to advertisers.

The Adpeer song is preferably distributed in either MPEG-1 Audio Layer 3 (“MP3”) or Windows® Media (“WMA”) format although other suitable formats such as WAV, AIFF or AAC can be used. Some portions of the file are encrypted, like the song itself, while other portions are not. FIG. 9 depicts a preferred format of an encrypted AdPeer song file. The components of the AdPeer song include: Header 905, Registration Announcement 910, Advertisement 915, Song 920. Also shown are randomly placed sync markers.

The Header 905 field contains standard MP3 tags that are utilized to identify the songs, trigger an Adpeer Client 107 and pop-up ads (which in one embodiment can be an HTML or a proprietary format playable by Adpeer Client 107), if the ad campaign requires this. One way to accomplish this is by triggering an associated banner ad within the music player, scroll associated text within the music player, display associated content and create associated links within the music player. The Registration Announcement 910 field contains an announcement and pop-up that allows the user to download the Adpeer Client 107 and register for free, legal music. Once the user has registered with the system (a “member”), the announcement is suppressed. The Advertisement 915 field in one embodiment contains a brief (approximately 5-15 seconds) ad that is originally distributed with the song, but can be dynamically replaced by AdPeer when it expires. The Song 920 field contains the music provided by the music company (and requested by the consumer). In one embodiment, the initial ad and the song has dual encryption protection that includes leading-edge AES block ciphers that is 256-bit key encryption as well as random sync markers that are placed into the song. Both measures make the song unplayable until registration has occurred. Other methods of encryption may also be utilized.

Distribution channels may include “unsanctioned” peer-to-peer networks (“P2P”) such as Kazaa™, Bearshare™ and Limewire™, as well as “sanctioned” networks like Napster™, i-Tunes™ and MusicMatch™. Other channels are Internet portals or websites where an AdPeer song can be downloaded and shared. Inevitably, encrypted AdPeer songs will show up on P2P networks such as Kazaa™ anyway, so an assumuption is that AdPeer songs will distributed through various means including P2P networks.

Using the present invention generally requires no arrangement with the P2P software companies to distribute the AdPeer songs. The Adpeer system simply “seeds” these P2P networks by putting encrypted AdPeer songs into the shared P2P folders on some of individual members computers. This is equivalent to “spoofing” except that the songs are playable and brings revenue to the music company.

2. The Life of an AdPeer Song

A. The First Time a Consumer Plays an AdPeer Song.

In one embodiment, whether a new consumer gets the AdPeer song from a P2P network or by some other sanctioned means, it arrives encrypted. If a consumer is not a registered member of AdPeer, the song won't play (see encryption measures above). Instead, they hear a friendly announcement asking them to register for the Adpeer service, and if they are online, they are taken to the AdPeer registration website. This website registers the user and steps them through the installation of Adpeer Client 107. Once installed, the song is playable, and Adpeer Client 107 takes control of decryption and reporting. Once registered, AdPeer users never hear the registration message again.

B. Once a Consumer has Registered and Installed the Adpeer Client, all New AdPeer Songs are Playable.

When a registered AdPeer user obtains other AdPeer songs, the Adpeer Client 107 automatically plays the songs. This process is transparent to the user.

The Adpeer Client 107 performs many functions for the AdPeer service. The Adpeer Client 107 is discussed in detail later, but briefly: (1) The Adpeer Client 107 encrypts and decrypts AdPeer songs before and after playing; (2) The Adpeer Client 107 “watches” the shared folders of all registered users to make sure that AdPeer songs remain encrypted so that they won't be transmitted in unencrypted form over various P2P networks; (3) The Adpeer Client 107 accumulates ad impressions and transmits them back to the AdPeer system in background when online; (4) The Adpeer Client 107 replaces expired ads with new ads, and may seed new songs on various P2P networks when instructed by the AdPeer system. Of course, not all the functions need to be implemented if desired.

3. Description of the AdPeer System Components

This section describes the various AdPeer system components in greater detail.

A. The Song Management Server 112.

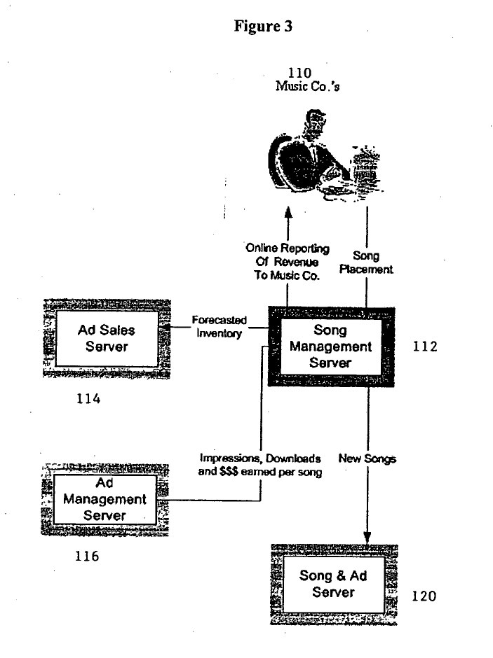

Referring to FIG. 3, the Song Management Server 112 performs at least one or more of three principal functions: (1) it manages the songs provided by the music companies for distribution; (2) it forecasts a song's download popularity; (3) it provides reporting back to the music labels over the web.

Song management begins when a content owner (such as a music label/company) provides a new song to AdPeer. In one embodiment, the song may be reviewed to make sure that it's content is not offensive. The song's approval status is tracked as part of the management process. The system converts the song into various distribution formats such as WMA and MP3 and sends it to the music company for quality review. The system may also receive a pre-approved library of songs from music companies in various distribution formats such as WMA and MP3, thus skipping the previous step. The Song Management Server 112 also manages the quality review and approval. Once songs are approved on the Song Management Server 112, they are then moved to the Song & Ad Server 120 for distribution to the AdPeer global audience. The Song & Ad Server 120 will be discussed in more detail later.

The Song Management Server 112 also forecasts a new song's download popularity. It does this so that advertising inventory can be calculated and sold to advertisers. For example, if a new song is expected to be downloaded at the rate of one million per month for the first three months, and played 15 times on average, then the first month's advertising inventory would be 15 million “listens” or impressions.

The Song Management Server 112 also provides online reporting to the music labels and AdPeer's own financial management staff. These online reports show the music labels how many people have downloaded a particular song, how many times the song has been played and how much ad revenue is owed to the music label based on this data. AdPeer tracks a lot of important data about these songs. For privacy and trust reasons, AdPeer will not report which users listened to which songs; however, AdPeer can aggregate information and report it to the music, companies. These reports can include the global geographical distribution of each song, the number of downloads for each age group, sex and average household income (in the US). The Ad Management Server 116, discussed later, feeds this data to the Song Management Server 112.

B. The Ad Sales Server 114.

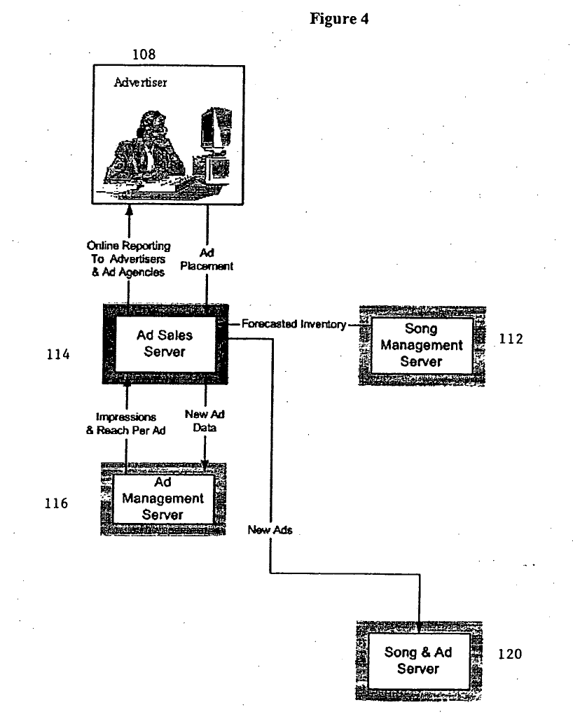

Referring to FIG. 4, the Ad Sales Server 114 manages all interactions between AdPeer and its advertising clients (or ad agencies). It performs one or more of four major functions: (1) it provides forecasted ad inventories and demographics to AdPeer's ad sales force; (2) it manages advertising “insertion” orders through the sales approval process; (3) it manages the trafficking and approval of the actual ads; and (4) it provides online campaign reporting back to advertisers and AdPeer management.

The Ad Sales Server 114 provides forecasts of available inventory to AdPeer's advertising sales force. These forecasts are based on the popularity of the songs AdPeer has distributed or will distribute in the coming months (see above). The ad sales force is responsible for selling the available inventory at the highest possible Cost Per Thousand (“CPM”) rate. Ad campaigns are sold by the number of impressions (or listens), but advertisers are equally concerned about reach (the number of people who will hear their ad). In addition, AdPeer offers the advertiser the important additional ability to more narrowly target their ad campaigns by any of the following: (1) DMA™ (Neilson designated market area), Metro™ (Arbitron Metropolitan Area) or Zip Code combinations; (2) Weighted Median Income (derived from zip code census data); (3) Music Genre; (4) Age range; and/or (5) Geography. It would be within the scope of one skilled in the art to include or use other factors such as interests (hiker, opera lover, etc.)

The Ad Sales Server 114 also tracks pending sales orders through order management approval. Once an order is accepted, the actual ad must be submitted by the advertiser or their ad agency to AdPeer. This ad must be reviewed and approved. This is known as “trafficking the ad.” Once finalized, it is moved to the Song & Ad Server 120 for distribution (discussed later).

The final job of the Ad Sales Server 114 is to store and report advertising results back to the advertiser and to AdPeer management. Impression data for each ad is accumulated every day via the Ad Management Server 116 (discussed later). AdPeer tracks the total impressions delivered, the age group of the listeners, the genre of the music the ad was carried in, the geographies delivered and the average median income. The system also displays the campaign's status, such as percent complete, started, not started, expired, etc. The Ad Sales Server 114 also reports the financial status of each ad. This includes the agreed price of the ad campaign, the amount “earned to date” based on impressions achieved, and the billed and unbilled amounts. Preferably the Ad Sales Server 114 interacts with AdPeer's accounting systems for billing (not shown in the diagram).

C. The Ad Management Server 116.

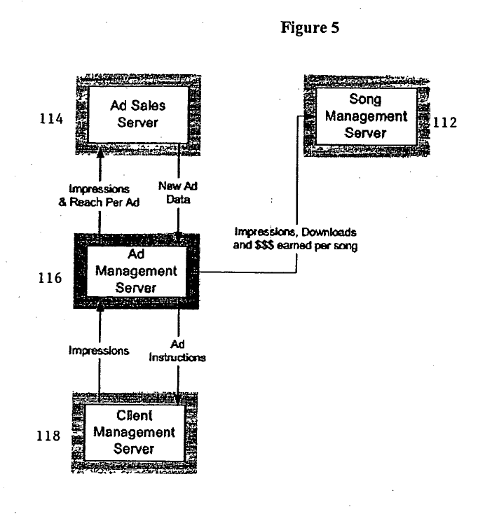

Referring to FIG. 5, the Ad Management Server 116 is the lynch-pin of the AdPeer system. Its chief role is to maximize ad revenue by ensuring that the requirements of each ad campaign are met and by supervising the ad replacement process when previously distributed ads have expired. Specifically, the Ad Management Server 116 does one or more of the following tasks: (1) it maximizes revenue to the music companies; (2) it makes sure that all ad campaign promises to the advertiser are met; (3) it accumulates impression counts for decision-making purposes and then recalls old ads and prepares ad replacement instructions and sends them to the Client Management Server 118; (4) it sends song seeding instructions to the Client Management Server 118; and (5) it sends impression count details to both the Song Management Server 112 and the Ad Sales Server 114.

The Ad Management Server 116 maximizes revenue by prioritizing and distributing ads with the highest CPM rate before scheduling lesser-priced ads. Of course, there are demographic and impression factors that are considered in this process ensuring that no decision is made based on price alone and that the ad, the song and the timing are all compatible. In short, The Ad Management Server 116 contains logic that ensures that ad campaign promises are met by achieving the demographics goals, the impression counts, and the reach of each campaign—all while maximizing revenue.

Once songs are in distribution, impression counts are sent back to AdPeer through the Adpeer Client 107 on each user's device. To collect and aggregate these impressions, the Ad Management Server 116 talks to an intermediate server (The Client Management Server 118) periodically throughout the day. The Client Management Server 118 bears the brunt of interacting with individual member devices so that the Ad Management Server 116 is able to focus on campaign management.

In the most rudimentary sense, an ad's status can be either “active” or it can be “complete” (i.e., expired). Of course there are more micro definitions of status, but for this discussion, two states are sufficient to describe the function. If, for example, an ad campaign calls for one million impressions, and that count has been reached, then the Ad Management Server 116 changes the status of the ad from active to expired. (It takes similar actions based on reach, demographics, etc.). The Ad Management Server 116 then sends a “recall” instruction to the Client Management System. The Client Management System makes sure that these ads are replaced on every consumer device when that device next interacts with the AdPeer system. The Ad Management Server 116 also determines the next ad each type of consumer should be sent once their old ads are recalled.

Ads may be recalled from a particular user for other reasons. For instance, an ad campaign that was intended for New York could reach a user living in Chicago (quite possible given the nature of P2P sharing). The user's ad should be recalled and replaced by a paying ad. The Ad Management Server 116 detects these conditions vis-à-vis the Client Management Server 118 and sends recall instructions to the Client Management Server 118 for execution.

The next important function of the Ad Management Server 116 is to send “song seeding instructions” to the Client Management Server 118 for distribution to various devices. This activity is further explained below.

Recall that the music companies have given new songs to AdPeer, and that advertisers have given AdPeer new ads. AdPeer has also have forecasted the download popularity of the song. Based on this data AdPeer personnel determine which new ads should originally be attached to new songs, and they bind them together and put the finished product on the Song & Ad Server 120. These songs will be made available to the public through various Internet portals or websites, but they may also be “seeded” onto P2P networks using the claimed process below.

On embodiment is to distribute the songs without the ads and insert these ads dynamically when a user goes to play a new song, however, this is not as efficient for the current distribution channels for several reasons: (1) The user may be offline when they go to play the song, making ad retrieval impossible; (2) dynamic ad retrieval for dial-up users would take too long; (3) it is risky to distribute songs without ads in case the new song should make it out onto the P2P networks; (4) distributing the song with the ad dramatically reduces the volume of hits on the Song & Ad Server 120; and, (5) ads are delivered using the public network rather than our expensive private network.

Once the new song and the ads are ready for distribution they are “seeded” onto the various P2P networks. Seeding is technically simple. Various AdPeer users are also members of various P2P networks. This fact is known by the Adpeer Client 107 running on each member's device. If AdPeer determines that it wants to seed a new AdPeer song onto a P2 P network like KaZaA in Chicago, for example, then a seeding instruction is sent from the Ad Management Server 116 to the Client Management Server 118. The next time the Client Management Server 118 is contacted by an Adpeer Client 107 running on a device in Chicago who's user is on the KaZaA network, that Adpeer Client 107 is given the seeding instruction. This instruction simply tells the Adpeer Client 107 to go get this new song from the Song & Ad Server 120 and place it into the shared KaZaA folder on its device. This makes the new AdPeer song available to other KaZaA users. 10,000 such seedings may be done throughout the various major cities in the US. After this original seeding the song and its ad spreads virally throughout the P2P network. The seeding will usually be done just before the radio air date so that the song is available in very large numbers on the P2P networks when people go to find it.

Finally, the Ad Management Server 116 sends impression count details to both the Song Management Server 112 and the Ad Sales Server 114. It gets these impression counts periodically throughout the day from the Client Management Server 118. The detail contains aggregate impression counts by song, zip code, age and sex and ad campaign. The Ad Management Server 116 augments the data with other attributes such as median income (derived from census data) and genre derived from the song. This is summarized and fed to the Song Management Server 112 and Ad Sales Server 114 for online reporting.

D. The Client Management Server 118.

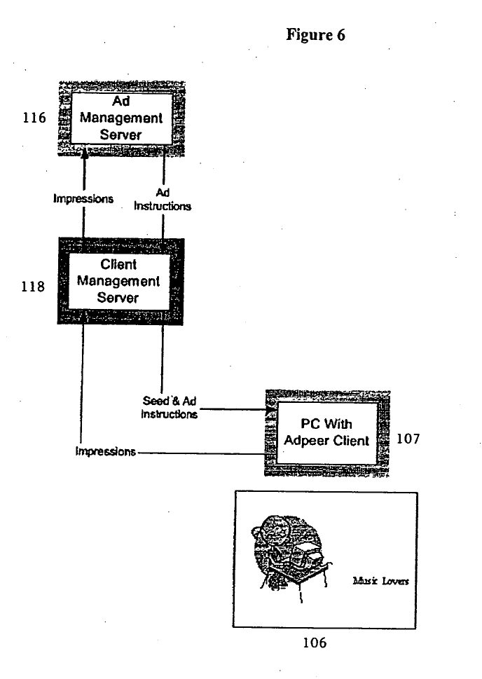

Referring to FIG. 6, the Client Management Server 118 is the “liaison officer” of AdPeer system that directly interacts with (eventually) millions of individual member devices. (As the AdPeer network of members grows globally, there may be various Client Management Server 118 servers located in several regions of the world for load balancing purposes.) This server performs one or more of the following functions: (1) it receives impression data from Adpeer Client 107s installed on each registered user's device; (2) it relays Ad Management Server 116 instructions to each device to recall and retrieve new ads; (3) it passes cumulative impression data daily to the Ad Management Server 116; (4) it relays seeding instructions from the Ad Management Server 116.

For reasons of volume, the Adpeer Client 107 running on each user device only attempts to contact the Client Management Server 118 once per day. The decision for having the Adpeer Client 107 contacting the Client Management Server 118 once per day is a practical decision, not a technical barrier. Frequency of contact may change based on the introduction of new technology or through better understanding of how the data might be transferred in a more efficient manner without negatively affecting the consumer experience. If the user is not online during a particular day, then the Adpeer Client 107 catches up the next time the user is online. The transactions between the Client Management Server 118 and each device are usually very small: impression counts are sent to the Client Management Server 118 and ad replacement instructions (if any) are sent back to the device via the Client Management Server 118. When the Client Management Server 118 instructs an Adpeer Client 107 to replace an ad with a new one, the Adpeer Client 107 fetches that ad from the Song & Ad Server 120, not from the Client Management Server 118 itself.

Sometimes the Client Management Server 118 may instruct a given device to participate in seeding a new AdPeer song on a P2P network that it is attached to. If so, this instruction is passed by the Client Management Server 118 to the Adpeer Client 107. The Adpeer Client 107 retrieves this song from the Ad & Song Server, not the Client Management Server 118.

E. The Adpeer Client 107.

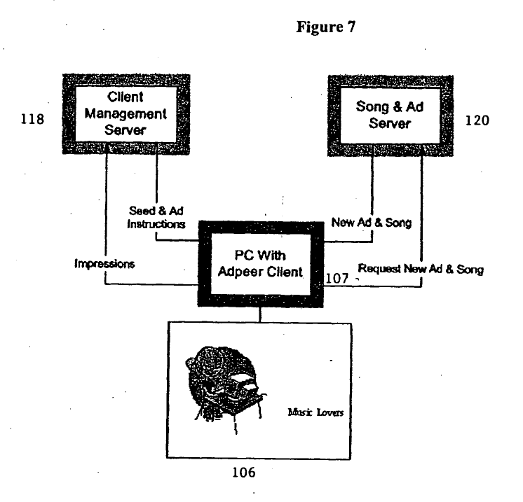

Referring to FIG. 7, the Adpeer Client 107 is a small application that is installed on each user's device preferrably either before or when they register. It operates exclusively in background either as a “system hook” at the operating system level and/or is integrated with a digital media player. A system hook is used for exemplary purposes and would generally be known to those skilled in the art. The Adpeer Client 107 performs one or more of the following functions: (1) it gathers impression counts by ad and song when the user plays AdPeer songs on his/her device; (2) it receives ad recall instructions from the Client Management Server 118 and replaces old ads; (3) it seeds new AdPeer songs; (4) it performs customized user functions that allow the user to more easily receive and share AdPeer songs.

The most important function of the Adpeer Client 107 is to make encrypted AdPeer songs playable. It does this just before the song is played by the user's media player.

The Adpeer Client 107 also gathers impression counts by ad and song when the user plays AdPeer songs on the user's device. Since the user may be off-line when the songs are played, these impression counts are accumulated until they can be transmitted in background to AdPeer's Client Management Server 118.

The Adpeer Client 107 also executes ad recall instructions received from the Client Management Server 118. These recall instructions indicate which ad in which song is to be replaced. The Adpeer Client 107 retrieves the new ad from the Song & Ad Server 120, and then replaces the old ad contained in the intended song. (Note that because songs have different genres, different ads are best suited for different songs. If the ad campaign is targeting a rock 'n roll audience, then those ads will be inserted during ad replacement into those types of songs. This is part of the ad recall instruction.)

As discussed previously, the Adpeer Client 107 can also help seed new AdPeer songs. It gets these instructions from the Client Management Server 118 and retrieves the actual encrypted, ad-embedded song from the Song & Ad Server 120. It deposits these songs into the user's shared P2P folders.

Finally, it is important to note that the Adpeer Client 107 can do other custom activities based on agreements with the music company. For example, if a user right-clicks on a song, the Adpeer Client 107 can drop down a list of useful operations related to the song. This list of operations could include: (1) share the current AdPeer song with a friend (this would be encrypted, of course); (2) initiate email notices to the AdPeer user regarding new AdPeer songs from the artist of the current song. This feature would encourage users to get their songs from AdPeer rather than illicit P2P networks; and/or (3) enable the user to buy the current song (stripped of the ad and encryption) by initiating a transaction to buy the song. The ad and encryption are removed from the Adpeer song after payment.

F. The Song & Ad Server 120.

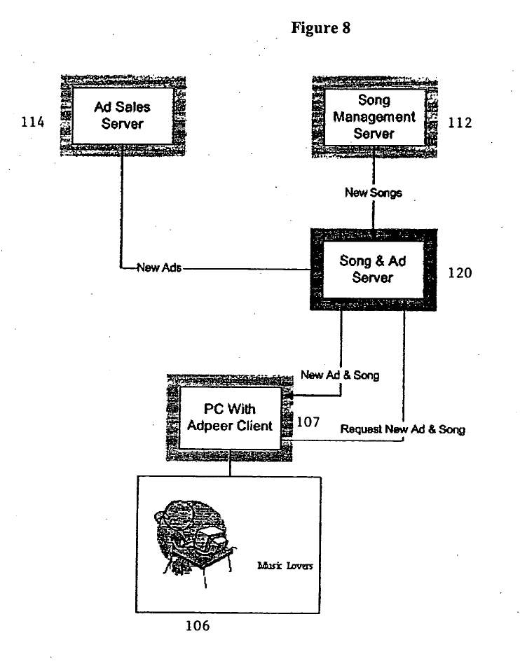

Referring to FIG. 8, the Song & Ad Server 120 serves as the repository for all AdPeer assets. The Song & Ad Server 120 performs the following one or more principal functions: (1) it stores raw songs and ads under development as well as ad-embedded songs ready for distribution; (2) it also stores approved ads so they are available when ads are to be replaced on individual devices; and (3) it is accessed by the Ad Sales Server 114 and Song Management Server 112 for review and approval purposes and by the Adpeer Client 107 when new ads or songs are needed.

4. Forecasting

In accordance with another aspect of the present invention, there is now described a system and method for forecasting and managing advertising impression and orders.

A. Inventory Forecasting

i. Forecasting Methodology

AdPeer sells advertising “impressions” to advertiser. In the context of audible content such as a song, an impression is a single listen to an ad embedded in an AdPeer song. AdPeer sells future impressions to advertisers a month or two ahead of when the ad will run. In order to do this, AdPeer needs to forecast the total future ad impressions it has available to sell. As AdPeer sells this future inventory, the remaining inventory balance must be maintained so that AdPeer knows how much is still has left to sell. Consequently, the first simple but important principle is that forecasted inventory (“f”), minus approved and pending sales orders (“o”), equals available inventory, (“a”):
(f−o=a)

In one embodiment, Impressions are sold to advertisers in four ways: By DMA or Metro, age range, sex and by genre (or any combination of these). These variables are the keys or “dimensions” of the Forecast Table and the Order Table.

When an order is taken, it is entered into an Order Table (“0”). Because the dimensions are exactly the same as the Forecast Table (“F”), their totals can be “subtracted” from one another to get the net impression remaining for sale. For example, the Forecast Table might have a projected total impressions of 200,000 for September's, 12-18 year old girls, living in the New York DMA for the rock and roll genre. The Order Table might have a sold number of impressions for these same dimensions of 150,000. Subtracting the two leaves 50,000 impressions left to sell. In terms of the database design, these key balances are kept in the Forecast Table. They include the forecast of impressions for sale, the sum of the impressions sold to-date, and the impressions remaining for sale. Impressions sold to date are stored as two totals, pending sales and approved sales.

In accordance with one embodiment of the present invention, the data is stored as an OLAP data cube that summarizes the data in the Forecast Table, although other database structures may be used. This cube, call it F′, is preferably maintained dynamically. New orders placed into the Order Table, should reduce the remaining impression count immediately so that inventory isn't oversold during the day. The cube is used by, for instance, sales people so that they know what is available for sale. According to one aspect of the present invention, the data is available for access, for instance, vial a pivot table in Excel, or it can be remotely accessed via the Internet or wireless connections.

B. Forecasting Future Inventory

Forecasted inventory is made up of two types of impression data: New Song forecasts and “mainstream” forecasts. When a song is 1-3 months old (although other time frames may be used), it's considered new, and needs special forecasting techniques. This is because New Songs are generally in higher demand than songs that have been in distribution for a while, so they have to be forecasted differently. The forecast for mainstream songs can be based solely on the previous month's actual history.

In this connection, the Forecast Table, F described above, is constructed from two parts: A New Song Forecast Table (“Fn”) and a Mainstream Forecast Table (“Fm”) are calculated and then summed together to give the final Forecast Table (i.e., Fn+Fm=F). The two tables Fn and Fm are built very differently, as will be describe further below.

i. The New Song Forecast Table (Fn)

When AdPeer is given a song by a record company, it works out the song's anticipated download profile. (This is preferably managed by the Song Management Server 112.) Knowing its download demand and the number of times on average the song will be listened to after download gives the forecasted impression inventory (downloads×listens=forecasted impressions). The general scheme is that AdPeer enters a “demand profile” for each new song. Since the dimensions of the forecast table are age range, sex, genre and DMA, ultimately a new song's forecast has to include all of these dimensions. (A song has only one genre, so the forecast for the song is specific to its genre.) The steps for forecasting new songs are described below.
a. Step 1. Estimate Downloads Expected (Mo. 1-3)

First, a song's download forecast is recorded, by, for purposes of this example, song managers. Referring to the table below, the bottom row is an example download estimate for the first three months:

Downloads Per Mo.

| Mo. 1 | Mo. 2 | Mo. 3 |
|---|---|---|
| 150k | 300k | 200k |

b. Step 2. Convert to Impressions Per Month.

The downloads per month are converted to impressions per month by another input. Song managers next estimate the impressions per download. This is a single number, such as 15—meaning 15 impressions (listens) per download. So if 15 listens per month are anticipated, then the table above gives a final impressions per month by multiplying all quantities by 15:

Impressions Per Mo.

| Mo. 1 | Mo. 2 | Mo. 3 |
|---|---|---|
| 2250k | 4500k | 3000k |

c. Step 3. Determine Age Distribution.

Working with the music company, the song manager estimates the age profile of listeners. For example:

| Age Range | % Distribution |
|---|---|
| 12-18 | 60% |
| 19-25 | 30% |
| 26-31 | 10% |
| 31-36 | 0 |
| Total: | 100% |

Preferably, the standard age ranges are the same as radio advertising, although this may change depending on the client marketing profile, etc. In this example, the table says that 60% of the impressions will come from 12-18 year olds, etc.

Matrix-multiplying the rows of the impression table by the column of the age distribution table gives the following:

| Age Range | Mo. 1 | Mo. 2 | Mo. 3 |
|---|---|---|---|
| 12-18 | 1350k | 2700k | 1800k |
| 19-25 | 675k | 1350k | 900k |
| 26-31 | 2250k | 450k | 300k |

d. Step 4. Determine Sex Distribution.

As with age range distribution, song managers will estimate the sex distribution of the song. This is just the two percentages, say, Male=30% and Female=70%. These numbers can be applied to the table above to subdivide each of the age ranges impression estimates into their male and female breakdown.

In one embodiment, when a new song is given to AdPeer by a music company, song managers record this profile through a set of “song management” screens. Song managers input only the download estimates, age distribution and gender distribution, the system does all of the math at the time of forecasting.

e. Step 5. Determine Geographical Extrapolation.

At this point, the age range, sex and genre distribution (which is the distribution of the genre that the song has been classified as) has been determined, but not geographical distribution. Geographical distribution is critical because most of the inventory (like radio) is usually sold on a spot basis by DMA or Metro. So, preferably, the final forecast for the song has to be by DMA or Metro.

To do this, in one embodiment, take last month's actual impression distribution pattern and apply that distribution pattern to the new song forecast. Accordingly, another table of the previous month's distribution of AdPeer impressions by age range, sex, and DMA or Metro and genre is needed. This table is the Impression Distribution Table (“IDT”). The IDT will have many uses in the system of the present invention. The IDT always reflects the last full month's activity. The system maintains this table by simply counting every impression and categorizing them by the four standard dimensions. The contents of the “cells” in IDT matrix are the number of total impressions received last month for the given age range, genre, sex, and DMA or Metro. (Because it always refers to the last complete month, the system accumulates the data for the current month's IDT table and at change of calendar month, throws the old one away.)

The actual algorithm to distribute the Song forecast by DMA or Metro is summarized in Steps 1-5 above, which gives the estimated TOTAL impressions for each sex and age range combination. (Genre is given by the song.) These attributes isolate a specific row of the IDT. That row has the impression counts last month for each DMA or Metro. If these impression counts are turned into percentages and then multiplied by the total forecast, the DMA or Metro distribution of the total forecast is determined. Since the forecast for this example is for three months, this has to be done three times, once for each month of the forecast. This procedure gives the final forecast for the upcoming three months for the new songs, i.e., Fn. The Mainstream Forecast is determined next.

f. Step 6. Mainstream Forecast Table (Fm)

This table uses the impression history from the previous month in order to estimate activity for the next month for all songs that have gone mainstream. Two steps are needed to build this table for the upcoming three month forecast: (1) Starting with the IDT table, subtract out all New Song activity, since their impression count forecasts are in Fn. Then (2) adjust the remaining impression downward by 10%. The downward correction is necessary so that we don't over-forecast inventory. (The 10% is somewhat arbitrary and will be a system variable so that management can change it from time to time.) The resultant Fm table has the same dimensions of age range, sex, genre and DMA as the Fn table.

g. Step 7. Total Forecast Table (F)

Finally, F can be derived as the matrix sum of the Fn and Fm tables. This table contains the forecast of all impression counts for the upcoming three months for both new and mainstream songs.

C. The Design & Maintenance of the Forecast Database

The Forecast Table F is actually a set of records in the database that have the following layout:

| | | | | | | | Imp. |
|---|---|---|---|---|---|---|---|
| Demographic | | | | | Pending | Approved | Available |
| Key | Month | Fn | Fm | F | Imp. | Imp. Sold | for Sale |
| Genre, sex, | September 2003 | 1,300,000 | 700,000 | 2.0 mill. | 1,000,000 | 300,000 | 700,000 |
| DMA, Age | | | | | | | |

Notice that in the physical database design Fn and Fm are combined, and F is calculated when the record is written to the database. These records can be rolled up to the Forecast Data Cube, F′, for use by ad sales personnel and management. Of course, other layouts may be used and techniques to create different database structures are well-know to those skilled in the art.

Regarding the maintenance of the Forecast Table, the new song forecast, Fn, has to be re-forecasted every night, at least if new songs have been provided (or retracted) by the music companies during the day. Fm is very stable, since by definition it is the forecast for songs that have been in distribution for more than 3 months. Fm is only calculated one a month at the change of the month.

5. Taking Orders and Managing Remaining Inventory

Recall the formula f−o=a. At this point, f in the equation has just been calculated. Attention is now turned to orders and order management.

A. Taking Orders

In accordance with one embodiment, order taking is managed by AdPeer's Ad Sales Server 114. An order in AdPeer consists of the following data elements:
Order number,
campaign ID,
order status,
Order start and end date
total impressions contracted for,
contracted CPM rate,
Contract Value (CPM rate×contracted impression/1000),
The demographic requirements of the order: sex, DMA(s), Age Ranges, genre.

Ad ID (which points to an actual ad in the Song & Ad Database)

To keep order complexity down and make system processing easier, there may be some limits on the demographic complexity of an order. Examples might include:
Sex can be M, F or * (meaning any).
Any combination of the six age ranges are valid.
Clients must specify either a single genre or * for any genre.
Clients can specify up to three DMAs on an order or *, meaning any DMA. (By inference, an * in the DMA field means the order is a nationwide order.)

An order progresses through several statuses: New, Pending (AdPeer's management approval), Approved, Declined, In-progress, Completed, Cancelled and Archived. When a new order is first entered into the system by the salesperson, it has a status of New. It remains in this status until the client and sales person agree on the details of the order. The sales person then changes the status to Pending, meaning it's awaiting AdPeer management approval. As discussed in the previous section, pending orders effect the remaining inventory balance in the Forecast Table because management must see their effect on inventory in order to approve them. If the order is declined, the order is reversed from the Forecast Table and the impressions it would have consumed are available for sale.

Orders that are entered with a fully qualified demographic key (i.e., no asterisks) are used to update the relevant records in the Forecast Table. Orders with asterisks need special treatment. These types of orders are called “partially qualified orders”, because some of their demographic requirements are fully qualified by the customer (say, males only) and others are partially qualified (such as “any genre”—i.e., genre=*).

B. Handling Partially-Qualified Orders

It would be reasonable to assume that if there is an order with an * in, say, the DMA field that the order should be spread across all the DMAs in the Forecast Table. However, if SQL is used, this is not necessary. Instead, additional records can written into the Forecast Table when these types of orders are entered that give these balances to the sales people. For example, recall that the original Forecast Table spread the forecast across all DMAs, genres, sexes, and age ranges. Let us say now that a pending order comes in for 200,000 impressions for: all DMAs (*), only males, 13-18 years of age and the rock-n-roll genre.

From the demographic key an SQL statement can be formulated against the Forecast Table that returns the sum of all forecasted, approved and pending impressions where: DMA=any, age range=13-18, sex=m and genre=rock. Once these totals are ascertained, they are added in the current order's impressions and this record written into the forecast table:

| Demographic Key | Month | Forecast | Pending | Approved | Remaining |
|---|---|---|---|---|---|
| Rock, Male, | September | 1,000,000 | 200,000 | 900,000 | (100,000) |
| DMA = *, Age = 13-18 | | | | | |

This new record becomes part of the Forecast Table. Notice that the order caused an over-sale condition because the remaining balance is negative. This order would probably not be approved by management. (In fact, the sales person should be warned of this condition when they entered the order.) Also notice the * in the key of the Forecast Table for DMA. This implies that the Forecast Table and the OLAP cube derived from it will have partial total records in it.

FIG. 9, depicts a sample pivot table that might be derived from the Forecast data cube, F′. (Different numbers are being used for this sample.) The “*” in the DMA column of the report means that there several orders exist with * in the DMA field, whose forecast, approved and pending totals are shown. The grand total shows the inventory remaining for sale.

6. Managing Orders In-Process

At any point in time, approved orders are being “fulfilled” by the system. Fulfillment is accomplished in two ways in the AdPeer system: (1) by embedding the ad associated with an order into a series of songs that are distributed to the public, and (2) by replacing expired ads on consumers devices. The vast majority of order fulfillment will be done through the second method since there will eventually be vastly many more songs out on individual users' devices then new songs now being distributed. Consequently, this write-up will focus on fulfilling orders through the second method, however, the logic of order fulfillment is the same when deciding which ad should go out on which new song when they are first being distribute.

Orders are constantly being started, fulfilled and completed. It is crucial to manage orders so that each order ends up being fulfilled, but also to maximize revenue by fulfilling higher-valued orders first. In addition, it is important that a consumer not get too many songs with the same ad, because it is annoying, and the extra listens by the same consumer are essentially wasted. So, managing orders in-process has three objectives:
Make sure all orders are fulfilled
Maximize revenue by fulfilling higher-valued orders first
Mix ads well enough so that a consumer isn't over-saturated with the same ad on too many songs.

These requirements may seem a bit daunting, but it turns out not to be too difficult.

A. Method Used to Fulfill Orders & Maximize Revenue

The Ad Management Server 116 manages ads. The Ad Management Server 116 chief functions include:
Determines which ad should be embedded in which songs;
Maximizes [insert]
Accumulates Impression Counts From [insert]
Recalls expired/old ads from the Client device
Passes Song Seeding Instructions to the CMS
Prepares New ads for Insertion Into Songs
Passes Impression Count details to the SMS and the ASS.

The Ad Management Server 116 maintains an Order Table. FIG. 1 is an

| | | | | | | Forecast | |
|---|---|---|---|---|---|---|---|
| Ord. | Start | End | Impressions | Impressions | Order | at End | |
| Id. | Date | Date | ordered | To-Date | Value | Date | Ad ID |
| 223 | Jan. 01, 2003 | Jan. 21, 2003 | 1,000,000 | 60,000 | $100,000 | 30% | xxx |
| 412 | Jan. 01, 2003 | Jan. 31, 2003 | 500,000 | 20,000 | $150,000 | 30% | yyy |
| 121 | Jan. 01, 2003 | 0/125/03 | 2,000,000 | 400,000 | $120,000 | 120% | zzz |

Most of the columns are self-explanatory; a few need explanation. Order Value is the product of the CPM rate (not shown) and the total impressions contracted for in the order. The Forecast At End Date is not obvious, but is a critical field that will govern a good deal of the order processing.

The Forecast at End Date is a linear projection of the impressions that will be achieved at the end date of the order, given the number of impressions achieved so far. For example, if the date is currently Jan. 5, 2003, and the first order became active on Jan. 1, 2003—then 5 days has elapsed and 60,000 impressions have been achieved so far. This amounts to 15,000 impressions per day. Since the first order has a total of 20 days duration, at this rate it will achieve 300,000 by the time the order end date is reached (20 days×15,000). 300,000 is only 30% of the contacted impressions, and this is the value of the Forecast at End Date. (By convention, the system will round the Forecast at End Date to the nearest tens place.)

Orders with a forecast less than 100% are in trouble. At the current rate, AdPeer will not fulfill this order. To correct this deficiency, more of this order's ads in distribution are needed so that its daily impression rate increases. This implies that when asked for a new ad by the Client Management Server 118, the system should make sure that the ads associated with this order get distribution priority. Hence, a primary rule for order distribution is: The lower the forecast, the higher the distribution priority.

Notice that this rule elegantly makes order prioritization self-adjusting. At the beginning of the month, all new orders have a zero Forecast at End Date, because their impressions to-date are zero. These orders have the highest priority. As an order's forecast grows from 10% to 40%, 70% and eventually 100+%, its priority decreases, until at 100% or greater, its priority is essentially zero, meaning that there is enough in circulation that the order will be filled on time, and no more ads need to be sent out. However, the Forecast at End Date is recalculated periodically, for instance, every hour or so, by the Ad Management Server 116. Should the rate of actual impressions per day for such an order start to decline, then its forecast will decline from 100% to, say 90%, and its priority will increase. Its ads will be sent out again by the system until its forecast returns to 100%. The self-adjusting nature of this algorithm will help ensure that most orders are filled.

At this point, fulfilling the orders have been discussed, but not maximizing revenue. Attention is now drawn to the role of Order Value.

Even though the Forecast at End Date is the primary determinant of an order's priority, what if there are two orders with the same forecast? For example, as mentioned earlier, at the beginning of a month all new orders have a forecast of zero. In this case, Order Value can be used to determine which order's ads are sent out first. This way, should some orders go unfulfilled before their end dates are reached, revenue has been maximized by sending out the higher valued orders first. Hence, Order Value is used to set priority for two orders with the same forecast.

Combining the results so far gives the following rule for determining distribution priority: Order priority is determine first by sorting descending by forecast and then sorting ascending by Order Value. (This is the order shown in the example above.)

Finally, it is important to note that it is not sufficient to know the ideal priority for a group of orders. It's also critical that an order with a higher priority be given out more than one with a lower priority, otherwise they will all end up with equal distribution. How much more frequently should an order with a Forecast at End Date of zero be given out than one with a forecast of 50%? It turns out this can be calculated by the formula:
Frequency=(100%−Forecast-at-end-date)/100
(Where Forecast-at-End-Date is made equal to 100% when it's 100% or greater.)

The Table below shows the possible frequencies for the various forecasts.

| Forecast at | |
|---|---|
| End Date | Frequency |
| 100+% | 0 |
| 90 | 1 |
| 80 | 2 |
| 70 | 3 |
| 60 | 4 |
| 50 | 5 |
| 40 | 6 |
| 30 | 7 |
| 30 | 8 |
| 10 | 9 |
| 0 | 10 |

What this frequency means in practice is that orders with a zero forecast are given out 10 times, for every one times that orders with a 90% forecast are given out. This is trivial to enforce by the As Management Server 116. As it gives out new ads, it keeps a counter of how many times the first ad has been given out. When the counter equals the frequency of the order, the Ad Management Server 116 goes onto the next ad in priority sequence. When it hits the bottom of the order list, it starts over again.

In summary, the following rules have been developed:
The higher the forecast the lower the priority
The priority of two orders with the same forecast is given to the one with higher order value
Distribution frequency is determined by the equation: Frequency=(100%−Forecast)/100

These rules are enacted by the system by sorting the active orders first by their forecast and then ascending within forecast by Order Value. Frequency is enforced by rotating through the active orders and giving them out as their frequency dictates before moving on to the next order.

B. Avoiding Same-Ad Overload

Another important goal of the system is to minimize ad redundancy to AdPeer members. This is not to say that a member should not get the same ad twice, but that it is desirable to minimize these occurrences. It should be obvious that it is often impractical for the system to keep track of every ad given to every user. Consequently, it is desirable to seek a practical and efficient distribution method that minimizes the probability of redundancy while achieving the frequency distribution objectives outlined in the previous section.

It may seem that when a member's device communicates with the AdPeer server and needs 10 new ads, that the system should just give it the top 10 ads on the priority list. While this minimizes redundancy, it causes an even distribution of ads rather than a weighted distribution based on the frequency needed to fulfill the orders. The example below shows what the results would be using this method.

When Ads Are Given Out All At Once . . .

| | Freq. | Member's and The Ads They Receive | | | | | | | | | |
|---|---|---|---|---|---|---|---|---|---|---|---|
| Ad ID | Req′ | A | B | C | D | E | F | G | H | I | J |
| a | 10 | a | a | a | a | a | a | a | a | a | a |
| b | 9 | b | b | b | b | b | b | b | b | b | b |
| c | 8 | c | c | c | c | c | c | c | c | c | c |
| d | 7 | d | d | d | d | d | d | d | d | d | d |
| e | 6 | e | e | e | e | e | e | e | e | e | e |
| f | 5 | f | f | f | f | f | f | f | f | f | f |
| g | 4 | g | g | g | g | g | g | g | g | g | g |
| h | 3 | h | h | h | h | h | h | h | h | h | h |
| I | 2 | I | I | I | I | I | I | I | I | I | I |
| j | 1 | j | j | j | j | j | j | j | j | j | j |

When the system gives a member all of it's needed ads at once, Ad redundancy is minimal, the distribution is even - the frequency requirements are not achieved.

A better method is to design the system so that when a device needs 10 new ads, it communicates with the AdPeer system 10 times. Because millions of devices will be communicating with the AdPeer system, it virtually guarantees that some number of other devices will have reached the server in the intervening moments between the time the original device got its first and then its next ad. This has the effect of randomizing the ad requests, so that when the ad server doles out ads as it works its way down the frequency distribution list, the chance that any one user will get the same ad are minimized. The table below shows the result using the same example from above, but with separate ad retrieval for each device. This method gives the required frequency distribution AND minimizes redundancy. For example, ad-ID a must be given out 10 times, so it is given to the first 10 users requesting an ad (Members A-J). Since the ad server has now satisfied the frequency requirements for Ad a, it moves on to ad b. It then gives ad b out nine times to the first nine members requesting another ad (members A-I). Moving on to ad c, it gives it out eight times—first to member J in row two of the table, and then to members A-G. And so on, until the ad server reaches the end of its order list and starts the whole process over again. (The pattern of ad distribution in this example is quite regular. In practice, member requests will be quite random, and the distribution pattern of ads users will be far more irregular.)

When ads are given out separately . . .

| | Freq. | Member's and The Ads They Receive | | | | | | | | | |
|---|---|---|---|---|---|---|---|---|---|---|---|
| Ad ID | Req′ | A | B | C | D | E | F | G | H | I | J |
| a | 10 | a | a | a | a | a | a | a | a | a | a |
| b | 9 | b | b | b | b | b | b | b | b | b | c |
| c | 8 | c | c | c | c | c | c | c | d | d | d |
| d | 7 | d | d | d | d | e | e | e | e | e | e |
| e | 6 | f | f | f | f | f | g | g | g | g | g |
| f | 5 | h | h | h | i | i | j | a | a | a | a |
| g | 4 | a | a | a | a | a | a | b | b | b | b |
| h | 3 | b | b | b | b | b | c | c | c | c | c |
| I | 2 | c | c | c | d | d | d | d | d | d | d |
| j | 1 | e | e | e | e | e | e | f | f | f | f |

When the system gives ads out one at a time, it achieves the frequency distribution desired while minimizing ad redundancy to the same user.

7. Mitigating Downside Risk

In the system described above of ad supported music, AdPeer pays the music companies a flat fee per download and receives its own compensation on a per listen basis. This presents AdPeer with a potential financial downside when consumers do not listen to enough music to cover the music companies' flat fee. To mitigate the downside risk there is now disclosed another embodiment of the present invention that ensures that the total revenue from consumer listening always meets or exceeds the total cost of consumer downloads.

In order to run ads against content, consumers must have content readily accessible by their AdPeer Client 107 (this will be described as songs or content “in” AdPeer Client 107). Without this content, the entertainment to support the ads would be non-existent. The Consumer Content Cost therefore is the total wholesale cost of the content a consumer receives from AdPeer. Take these values, for example:
s=number of AdPeer songs initially imported into AdPeer Client 107
w=wholesale cost of each song
p=the number of people who sign up for AdPeer service
c=consumer content cost
   The following formula applies:
   c=S*w*p

To illustrate a likely scenario, let's assume 1 million consumers sign up for the AdPeer service and download 20 songs each at a wholesale cost of $0.50. Given the formula above:
c=20*$0.50*1,000,000=$10,000,000

In this scenario, a Consumer Content Cost of $10,000,000 would be a financial liability until consumers listened to enough music to cover the cost.

To eliminate this exposure, AdPeer has developed a points redemption system whereby consumers accumulates points based on the number of ads they've listened to. Only when a consumer has listened to enough ads can they download another AdPeer song.

A. Listen Points

The system awards “Listen points” to a consumer for listening to advertisements on AdPeer Client 107. These Listen points can be tracked in different modules such as Client Management Server 118, Ad Management Server 116 or Song Management Server 112. Consumers build up Listen points over time and can exchange these points for free legal music. On average, it is estimates that free songs can be earned every hour and a half, although that will of course vary depending on the amount of points credited for each ad listed to and the frequency of listens. To maintain a good user experience, AdPeer Client 107 places ad frequency control in the hands of users. Users who wish to quickly earn Listen Points can set the player to play many ads per hour while other consumers are free to turn the ad frequency down to near zero. In one embodiment the consumer does this using a simple slider control within the player.

Listen points mitigate AdPeer's payment liability to the music companies by ensuring that Free Revolution has earned its ad revenue and profit for a song before the consumer is allowed to download it.

Listen Points and the number of points awarded for each ad listen are calculated in the following manner:
N=Number of listens need to earn a free song
L=Listen Points needed to earn a free song
w=wholesale cost of each song
m=profit margin (%)
r=revenue received from each ad listen
v=value multiple or the number of points earned per ad listen (included to support future offers that may not be the same cost as songs)

The following formula applies to calculate the number of ad listens needed to earn a free song:
N=w*(1+m)/r
To illustrate a likely scenario, the wholesale cost of a song is $0.50 to which is added a 15% profit margin and the revenue received from each listen is $0.025.
N=($0.50*(1+0.15)/$0.025=26

To deal with fractions of points and future offers the system multiplies a value multiple (v) on to (N). The value multiple is the number of points that will be earned for each ad listen. To calculate the final number of listen points needed to earn a free song the following formula applies:
L=v*N

Following this scenario, where the value multiple is 10, the number of listen points needed to earn a free song is as follows:
L=10*26=260

Note that L is a “system variable”, meaning it is stored in a reference table in the AdPeer system. In a typical business environment, management controls this variable based on the average ad rates the business is currently achieving. Each consumer's AdPeer Client retrieves the new value of L when it checks in to the Ad Management Server 116 directly or through the Client Management Server 118—which usually happens daily.

B. AdPeer Client 107

In one embodment, AdPeer Client 107 is installed on the user's PC. This is preferrably done when the user signs up for service or it may be installed before a user signs up. AdPeer Client 107 can be based on Microsoft's media player and has all of its functionality plus additional capabilities unique to the present invention. Standard functions include:
The ability to scan the user's computer and compile all of his/her songs
Ability to make and play playlists AdPeer Client 107 has additional capabilities:
The ability to intersperse ads between songs (like radio)
The ability to accumulate and display points earned
The ability for the user to control ad frequency
The ability, like iTunes, to search the AdPeer song library and download free songs or buy songs through the client
The ability to display album artwork
The ability to display graphical ad messages associated with the current audio ad being played
The ability to redeem points through the client
The ability to port ad-embedded songs to a portable media player
The ability to burn ad-embedded songs to CD (some music companies won't allow this)

It is important to note that AdPeer Client 107 can play ads in front of both songs that the consumer already owns and AdPeer songs. This allows the user to accumulate Listen points much faster (and allows AdPeer to earn ad revenue even when consumers are not playing AdPeer songs.) This ability is especially important when a member first signs up for AdPeer. Since they may not have any points in the beginning, the ability to earn listening points against their own song library is a critical feature.

In yet another aspect of the present invention, when a consumer signs up for the AdPeer service they will be presented with 2 options for software—a basic client and a premium client. The basic player is free and the premium player has a cost, such as $10. The premium player gives a new member a starter kit of Listen points, e.g. 4,000 points, so that the member can get AdPeer songs immediately. The two clients are compared below:

| | Basic Client | Premium Client |
|---|---|---|
| Consumer Pays (one time) | $0 | $9.99 |
| Plays music member already owns | Yes | Yes |
| Ad Frequency Control | No | Yes |
| Beginning Listen Points | 0 | 4,000 (actual number |
| | | will be determined at |
| | | system launch) |
| Ability to Transfer to MP3 Player | No | Yes |
| Ability to Burn to CD | No | Yes |

Both clients have the ability to play the consumers existing music files so that the client is immediately useful. From the table above you can see that the Premium Client user covers the downside risk of free music downloads out of their own wallet. The price is carefully calculated so that the number of points (and therefore songs) granted is equal to or greater than the dollar amount paid by the user.

When the user selects the basic client they are not granted points and, therefore, cannot immdiately download free music. They have to wait until they've listened to enough ads to cover the cost of the music yet they have no music in their player. Ads will run against the consumer's music collection allowing them to earn points for free music.

To note, the function of ads running against a consumer's music collection will be available on both the basic and premium client. This maximizes revenue against music not purchased from the music companies. This also gives consumers a benefit to give them a wide selection of music within their client.

In another aspect of the present invention, when a consumer with a basic client has earned the number of points granted to the premium client user they will automatically be upgraded to the functionality of the premium client.

C. Dealing with Non-Embedded Ads

In one aspect of the present invention, AdPeer Client 107 will run ads against any content run in the player. This includes streaming media (audio or video) from websites, downloaded content (audio or video) imported into or invoked by the client and free music received from AdPeer. To deal with ads that are not embedded in music, AdPeer Client 107 will download a cache of ads according to the same priority rules set previously for the Ad Server 116. Ads will run in a random non-repeating order in between songs at a frequency determined by the user's setting in the player.

To ensure that ads in ad-embedded songs are played, in accordance with another aspect of the present invention, users will not have the ability to suppress the ads in ad-embedded songs that are redeemed for points.

D. Ensuring Tasteful Content

For AdPeer advertisers, it is important that their brands are associated with content that supports the attributes of their brand. For the most part, anything that plays on public airwaves is fair game. However, there are some instances where advertisers would not want to be associated with a user's personal selection of content. Most notably this applies to obscene or pornographic material.

AdPeer generally does not filter all of the users personal choices. However, AdPeer can provide some measure of protection for the brands that are running on our network through an opt-in policy (as opposed to an opt-out).

In accordance with this apsect of the present invention, AdPeer will create an opt-in list for streaming media sites that are allowable for ad-supported content. If the user selects content from a non-approved site, they simply will not receive an ad for that selection. The opt-in list will include most mainstream sites for music, news and search.

For a user's offline or downloaded collection, AdPeer Client 107 will not play ads against video content, but will play ads against all audio content.

E. Targeting of Ads for Non-Embedded Ads

In another aspect of the present invention, AdPeer Client 107 will evaluate requested URLs or other standard meta data so that the client will be able to run more highly targeted ads against independent user requests. For example, if a user requested a streaming annual report webcast from Dell.com the ad chosen to run before that stream would contain a highly targeted ad to the group likely to be watching or listening to that annual report.

Having now described preferred embodiments of the invention, it should be apparent to those skilled in the art that the foregoing is illustrative only and not limiting, having been presented by way of example only. All the features disclosed in this specification (including any accompanying claims, abstract, and drawings) may be replaced by alternative features serving the same purpose, and equivalents or similar purpose, unless expressly stated otherwise. Therefore, numerous other embodiments of the modifications thereof are contemplated as falling within the scope of the present invention as defined by the appended claims and equivalents thereto.

For example, the present invention may be implemented in hardware or software, or a combination of the two. Preferably, aspects of the present invention are implemented in one or more computer programs executing on programmable computers that each include a processor, a storage medium readable by the processor (including volatile and non-volatile memory and/or storage elements), at least one input device and one or more output devices. Program code is applied to data entered using the input device to perform the functions described and to generate output information. The output information is applied to one or more output devices.

Each program is preferably implemented in a high level procedural or object oriented programming language to communicate with a computer system, however, the programs can be implemented in assembly or machine language, if desired. In any case, the language may be a compiled or interpreted language.

Each such computer program is preferably stored on a storage medium or device (e.g., CD-ROM, DVD-ROM, ROM, Flash ROMs, hard disk or magnetic diskette) that is readable by a general or special purpose programmable computer for configuring and operating the computer when the storage medium or device is read by the computer to perform the procedures described in this document. The system may also be considered to be implemented as a computer-readable storage medium, configured with a computer program, where the storage medium so configured causes a computer to operate in a specific and predefined manner. For illustrative purposes the present invention is embodied in the system configuration, method of operation and product or computer-readable medium, such as floppy disks, conventional hard disks, CD-ROMs, DVD-ROMs, Flash ROMs, nonvolatile ROM, RAM and any other equivalent computer memory device. It will be appreciated that the system, method of operation and product may vary as to the details of its configuration and operation without departing from the basic concepts disclosed herein.

1. A content distribution and revenue generation system, comprising:
a processor configured to:
receive a first and second content;
combine said first content with said second content;
lock at least said first content;
receive a user request for said first content from a user device;
in response to said user first content request, transmit said combined content to said user device; and
maintain impressions and billing information based on said transmission of said combined content.

2. The system of claim 1 further comprising said user device in communication with said processor for (i) requesting said first content, (ii) receiving and unlocking said combined content, and (iii) executing said first and second content.

3. The system of claim 1 further comprising a first content generation system in communication with said processor for providing said first content to said processor.

4. The system of claim 1 further comprising a second content generation system in communication with said processor for providing said second content to said processor.

5. The system of claim 1 wherein said processor is further configured to generate billing and revenue reports based on said impressions and billing information.

6. The system of claim 1 wherein said processor is further configured to update said second content and wherein after a predetermined time period said user device is further configured to request, receive and execute said first content and said updated second content.

7. The system of claim 1 wherein said processor is further configured to seed said user device with said combined content.

8. A content distribution and revenue generation system, comprising:
a processor configured to:
receive a first and second content,
combine said first content with said second content,
lock at least said first content,
receive a user request for said first content from a user device,
in response to said user first content request, transmit said combined content to said user device, and
maintain impressions and billing information based on said transmission of said combined content;
said user device in communication with said processor for (i) requesting said first content and (ii) receiving and unlocking said combined content and executing said first and second content;
a first content generation system in communication with said processor for providing said first content; and
a second content generation system in communication with said processor for providing said second content.

9. The system of claim 8 wherein said processor is further configured to generate billing and revenue reports based on said impressions and billing information.

10. The system of claim 8 wherein said processor is further configured to update said second content and wherein after a predetermined time period said user device is further configured to request, receive and execute said first content and said updated second content.

11. The system of claim 8 wherein said processor is further configured to seed said user device with said combined content.

12. In a content distribution and revenue generation system, a method comprising:
combining a first content with a second content,
locking at least said first content,
receiving a user request for said first content from a user device,
in response to said user first content request, transmitting said combined content to said user device, and
maintaining impressions and billing information based on said transmission of said combined content.

13. The method of claim 12 further comprising unlocking said combined content and executing said first and second content.

14. The method of claim 12 further comprising generating billing and revenue reports based on said transmission of said combined content;

15. The method of claim 12 further comprising updating said second content and after a predetermined time period, requesting, receiving and executing said first content and said updated second content.

16. The method of claim 12 further comprising seeding said user device with said combined content.

17. In a content distribution and revenue generation system, a method comprising:
combining a first content with a second content;
locking at least said first content;
receiving a user request for said first content from a user device;
in response to said user first content request, transmitting said combined content to said user device;
maintaining impressions and billing information based on said transmission of said combined content;
unlocking said combined content; and
executing said first and second content.

18. The method of claim 17 further comprising generating billing and revenue reports based on said impressions and billing information.

19. The method of claim 17 further comprising updating said second content and after a predetermined time period requesting, receiving and executing said first content and said updated second content.

20. The method of claim 17 further comprising seeding said user device with said combined content.

21. A computer-readable medium having computer-executable instructions for performing a content distribution and revenue generation method comprising:
combining a first content with a second content;
locking at least said first content;
receiving a user request for said first content from a user device;
in response to said user first content request, transmitting said combined content to said user device; and
maintaining impressions and billing information based on said transmission of said combined content.

22. A computer-readable medium of claim 21 wherein said computer-executable instructions further includes a method comprising receiving and unlocking said combined content and executing said first and second content.

23. A computer-readable medium of claim 21 wherein said computer-executable instructions further includes a method comprising generating billing and revenue reports based on said impressions and billing information.

24. A computer-readable medium of claim 21 wherein said computer-executable instructions further includes a method comprising updating said second content and after a predetermined time period requesting, receiving and executing said first content and said updated second content.

25. A computer-readable medium of claim 21 wherein said computer-executable instructions further includes a method comprising seeding said user device with said combined content.

26. A computer-readable medium having computer-executable instructions for performing a content distribution and revenue generation method comprising:
combining a first content with a second content;
locking at least said first content;
receiving a user request for said first content from a user device;
in response to said user first content request, transmitting said combined content to said user device;
maintaining impressions and billing information based on said transmission of said combined content;
receiving and unlocking said combined content; and
executing said first and second content.

27. A computer-readable medium of claim 26 wherein said computer-executable instructions further includes a method comprising generating billing and revenue reports based on said impressions and billing information.

28. A computer-readable medium of claim 26 wherein said computer-executable instructions further includes a method comprising updating said second content and after a predetermined time period, requesting, receiving and executing said first content and said updated second content.

29. A computer-readable medium of claim 26 wherein said computer-executable instructions further includes a method comprising seeding said user device with said combined content.

30. A client device for use in a content distribution and revenue generation system, comprising:
a processor configured to:
request at least a first content from a server device,
receive a locked combined content comprising said first content and a second content,
unlock said combined content to enable execution of said first and second content;
wherein said server device to:
combine said first content with said second content;
lock at least said first content;
receive from said client device said user request for said first content;
in response to said user first content request, transmit said combined content to said client device;
maintain impressions and billing information based on said transmission of said combined content.

31. The client device of claim 30 wherein said processor is further configured to receive said combined content for seeding.

32. The client device of claim 30 wherein said processor is further configured to, after a predetermined time period, request and receive from said server device updated second content and execute said first content and said updated second content.

33. In a computer-implemented system comprising a processor, a data structure to be read by said processor comprising:
a first field containing data representing a supressable first content for execution prior to a user, desiring a second content, having authorized access to said system;
a second field containing data representing said second content and
a third field containing data representing a dynamically updateable third content for execution with said first content.

34. The data structure as in claim 33 further comprising a fourth field containing identifiers associated with said first, second and/or third fields.

35. The data structure as in claim 33 wherein said second content is encrypted.

36. The data structure as in claim 33 wherein said third content is encrypted.

37. A client device comprising a media player that downloads and plays ads between requested consumer content independent of consumer requested content.

38. A client device of claim 37 wherein said media player can play targeted ads against requested consumer content by evaluating a requested url or other standard meta data.

39. A client device comprising a media player that creates a random, non-repeating order for said ads.

40. A client device comprising a media player that allows the user to control the frequency of ads played.

41. A client device comprising a media player that ensures advertisements are played against tasteful content.

42. A content distribution system comprising a points system tied to said media player for the redemption of awards.
